(19) United States
(12) Patent Application Publication
(10) Pub. No.: US 2003/0115087 A1
(43) Pub. Date: Jun. 19, 2003

(54) Technical support system

(75) Inventor: Toshio Ueno, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/002,745

(22) Filed: Nov. 2, 2001

(51) Int. Cl. G06F 17/60

(52) U.S. Cl. 705/7

(57) ABSTRACT

A technical support system includes an SIP section which provides web pages as an information input and output interface, a KB section which stores various claim reports and solutions related to the claim reports, and a CH section which registers in the knowledge base section a new claim report in which at least a claim title is structured as a combination of predetermined items of definition information on the basis of a claim content input to a client web page, and manages the registered new claim report as an unsolved claim requiring an answer from an engineer. Particularly, the CH section is configured to issue task sheets for a market countermeasure task which is shared among technical divisions according to the new claim report and to update the state of progress in the market countermeasure task upon receipt of the task sheet returned from each of the technical divisions.

### BACKGROUND OF THE INVENTION

The present invention relates to technical support system for providing technical support to various claims for manufacturer's own products acquired through a worldwide technical service network.

In recent years, many enterprises have overseas subsidiaries established as footholds for the marketing of products. In a typical enterprise, the subsidiaries sell products to end-users via, e.g. distributors and dealers. Besides, technical services such as maintenance and repair of products are provided to end-users from the dealers and direct service organizations. Major subsidiaries handle various claims reported directly from the dealers and direct service organizations in their assigned marketing regions, or indirectly from the distributors and subsidiaries. If the major subsidiaries have received claims that cannot be handled, they report such claims to an engineering and service department of the headquarters.

The engineering and service department acts as an agent between the subsidiary, which is a customer, and a product technology department of a factory or a third party vender. The engineering and service department demands a solution to the claim reported by the subsidiary from an engineer in charge in the product technology department. The engineer confirms the content of the claim, studies the cause of the claim, and carries out a supporting task for preparing the solution that can eliminate the cause. The engineering and service department confirms the solution provided by the engineer after the supporting task, produces a claim handling plan based on the solution, so as to meet individual technical support policies varying from market to market, and delivers the claim handling plan to the subsidiary as an answer document to the claim.

In the prior art, the dealers, direct service organizations, distributors, subsidiaries, major subsidiaries, engineering and service department, and product technology department are connected over a dedicated line or the Internet so as to have a hierarchical structure, as shown in FIG. 1. E-mail is used as an information transmission media. In the technical support, each service layer is always required to search databases, etc. to study solutions to claim reports, which have been sent from a lower-level service layer by e-mail. If solutions are not found, each service layer is required to request an upper-level service layer. Thus, arrears of claim reports may possibly occur in an escalation from the lowermost service layer to the uppermost service layer.

Since the main task of the product technology department is designing and manufacture of products, a delay in the supporting task will often occur even if it receives a request from the engineering and service depart. In such a situation that the supporting task cannot be started, the supporting task has to be suspended, or the cause of the claim cannot easily be identified.

Moreover, the engineering and service department cannot completely grasp the condition of progress in the delayed supporting tasks, and unsolved claim reports tend to accumulate. Besides, a solution to a claim that has arisen in connection with a product is not necessarily applicable to a similar claim that has arisen in connection with another product sold in a different market in which different product specifications are adopted. Thus, the engineering and service department needs to accept all claim reports from the subsidiaries that manage different markets.

Under the circumstances, the above-described technical support system will ultimately impose a heavy load on the engineering and service department and it would be difficult to fulfill their roles in the future without increasing the scale thereof.

### BRIEF SUMMARY OF THE INVENTION

The object of the present invention is to provide a technical support system which ensures speedy presentation of market countermeasures against claims concerning products.

According to the present invention, there is provided a technical support system comprising: a service information portal section which provides web pages as an information input and output interface; a knowledge base section which stores various claim reports and solutions related to the claim reports; and a claim handling section which registers in the knowledge base section a new claim report in which at least a claim title is structured as a combination of predetermined items of definition information on the basis of a claim content input to a client web page, and manages the registered new claim report as an unsolved claim requiring an answer from an engineer, wherein the claim handling section is configured to issue task sheets for a market countermeasure task which is shared among technical divisions according to the new claim report and to update the state of progress in the market countermeasure task upon receipt of the task sheet returned from each of the technical divisions.

According to the technical support system, the claim handling section issues task sheets for a market countermeasure task which is shared among technical divisions according to the new claim report, and updates the state of progress in the market countermeasure task upon receipt of the task sheet returned from each of the technical divisions. Therefore, the technical divisions can simultaneously carry out subtasks of the market countermeasure task. Additionally, even when it is necessary to await a task result from another technical division, the next subtask can be started without delay, immediately after acquisition of the task result. Therefore, the claim concerning the product can speedily be solved as a whole.

Moreover, the new claim report in which at least a claim title is structured as a combination of predetermined items of definition information on the basis of the claim content input to the client web page is registered in the knowledge base section, and is managed as an unsolved claim requiring an answer from the engineer. Therefore, it can be checked with a high precision whether or not a solution is already available with respect to the claim report. If the solution is found by a search, the claim can quickly be solved based on the solution. Accordingly, labor of the engineer required for verifying a necessity of the market countermeasures can be saved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a diagram showing the hierarchical structure of a conventional technical service;

FIG. 2 is a diagram showing the structure of a technical support system according to an embodiment of the present invention and a network connected to the system;

FIG. 3 is a diagram showing the flow of information in the technical support system shown in FIG. 2;

FIG. 4 is a diagram showing an example in which the technical support system shown in FIG. 2 is applied to the conventional hierarchical structure;

FIG. 5 is a flowchart illustrating a reporting process for an unformatted claim such as a claim report issued in a dealer shown in FIG. 4;

FIG. 6 is a diagram showing a synonym table for specifying problem codes in a knowledge base search shown in FIG. 5;

FIG. 7 is a diagram showing a synonym table for specifying unit codes in the knowledge base search shown in FIG. 5;

FIG. 8 is a diagram showing a synonym table for specifying error codes in the knowledge base search shown in FIG. 5;

FIG. 9 is a diagram showing the claim report prepared in the reporting process for unformatted claims shown in FIG. 5;

FIG. 10 is a diagram showing detailed contents of items incorporated in the claim report shown in FIG. 9;

FIG. 11 is a flowchart illustrating a reporting process for a formatted claim such as the claim report shown in FIG. 9;

FIG. 12 is a diagram showing a stepwise transition in a market countermeasure task carried out for the claim report by a whole product technology department; and

FIG. 13 is a diagram showing an example in which task sheets are used for managing the market countermeasure task shown in FIG. 12 to be shared among technical divisions.

### DETAILED DESCRIPTION OF THE INVENTION

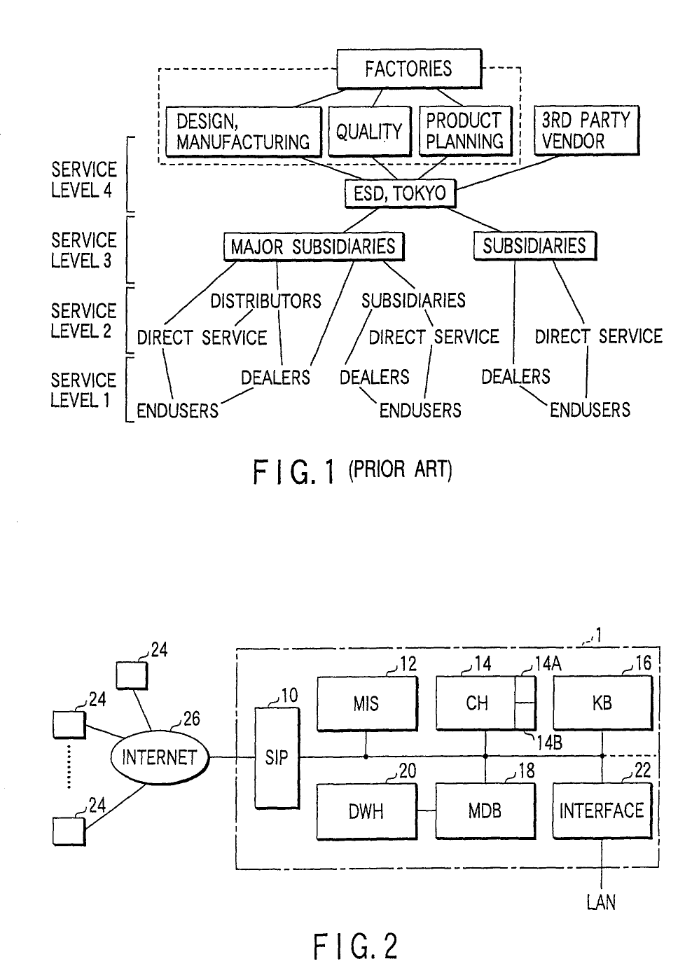

A technical support system 1 according to an embodiment of the present invention will now be described with reference to the accompanying drawings. The technical support system 1 is constructed to be also applicable to a hierarchical structure of technical service shown in FIG. 1, and serves as a server disposed in an engineering and service department in Tokyo, for example. This server is connected over the Internet to worldwide major subsidiaries as clients, which serve as sales footholds of products such as copiers and facsimile machines. The server, on behalf of staff of the engineering and service department, functions as an agent between the customer and the product technology department of the factory or third party vender.

FIG. 2 shows the technical support system 1 and a network connected thereto. The technical support system 1 comprises a service information portal (SIP) section 10, a management information system (MIS) section 12, a claim handling (CH) section 14, a knowledge base (KB) section 16, a master database (MDB) section 18, a data warehouse (DWH) section 20, and a communication interface 22. The SIP section 10, MIS section 12, CH section 14, KB section 16, MDB section 18, DWH section 20 and communication interface 22 for intra-company LAN are constructed as a combination of plural server computers connected, for example, over a shared system bus. The MIS section 12 and CH section 14 are incorporated into the technical support system 1 as application software of the server computers.

The SIP section 10 provides web pages to client terminals 24 over the Internet 26 as an information input and output interface. The MIS section 12 can access the client terminals 24 via the SIP section 10 and it collects and analyzes various report information. The master database 18 stores the overall information collected by the MIS section 12 as well as other information. The DWH section 20 stores an analysis tool for enabling the MIS section 12 to analyze the information stored in the MDB section 18. The KB section 16 stores various claim reports backed up also in the MDB section 18 and solutions answered by engineers of the product technology department with respect to the claim reports. The CH section 14 registers in the KB section 16 a new claim report in which at least a claim title is structured as combinations of predetermined items of definition information on the basis of claims input to the client web page provided by the SIP section 10. The CH section 14 manages the new claim report as an unsolved claim requiring an answer from engineers.

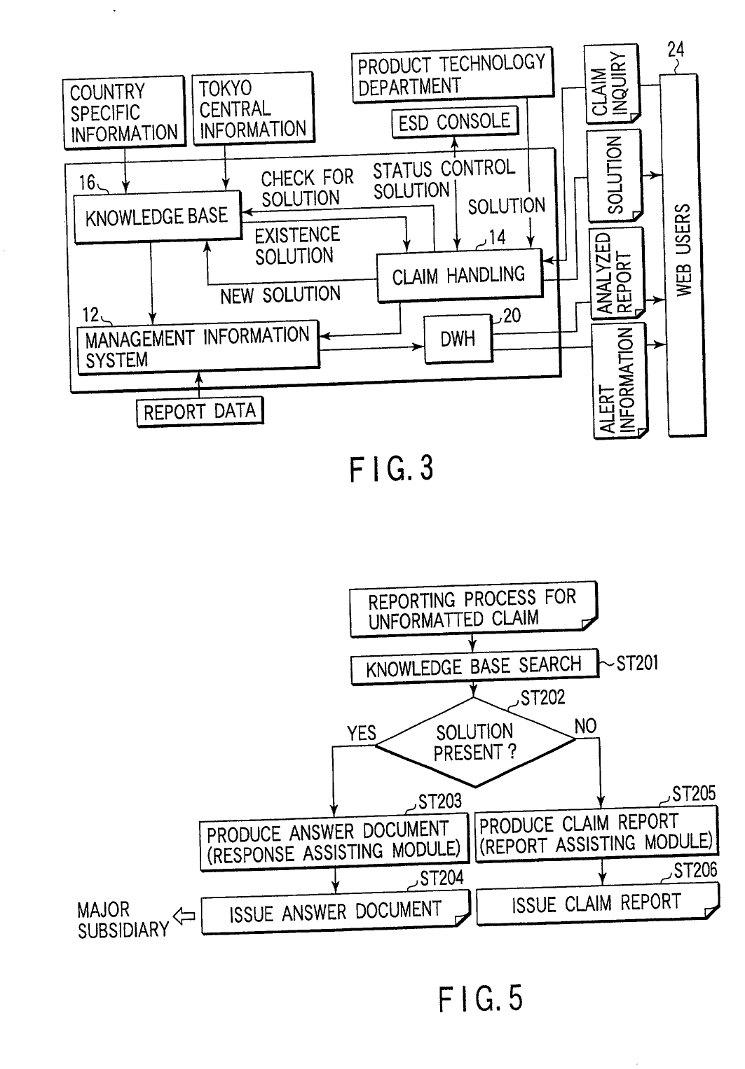

FIG. 3 shows a flow of information in the technical support system 1. If the client terminal 24, or a web user, issues a claim inquiry, it is delivered to the CH section 14 as a claim report. The CH section 14 checks the KB section 16 for a solution to the claim, and acquires the solution from the KB section 16. If there is no solution, the CH section 14 requests a solution from the product technology department and registers an acquired solution in the KB section 16 as a new solution. At the same time, the CH section 14 informs the client of the new solution as an answer document. The KB section 16 stores not only various reports and solutions thereto, but also country specific information and Tokyo central information supplied from the intra-company LAN. The country specific information includes individual technical support policies varying from market to market, the Tokyo central information includes inside materials and third party materials of related technologies. The CH section 14 is so constructed as to permit an operator working at the engineering and service department to confirm, through a console of the server computer, the current state of support for unsolved claim reports. The MIS section 12 collects various report information such as warrantee report data, call center data, set-up report data, service parts use data and claim report data, which are accumulated in the client terminal 24 side.

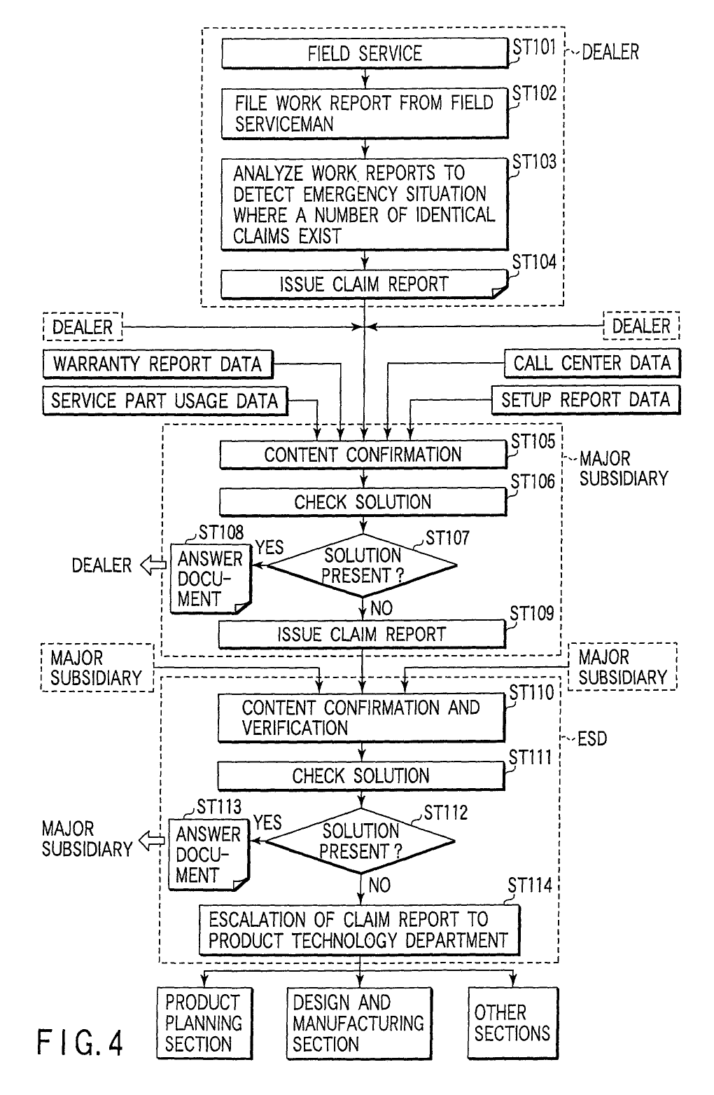

FIG. 4 shows an example wherein the technical support system 1 is applied to the conventional hierarchical structure shown in FIG. 1. In this example, the major subsidiaries alone are permitted to access the technical support system 1 via the Internet 26. None of the dealers, direct service organizations, distributors and ordinary subsidiaries are permitted to access the technical support system 1. In the dealership, a field serviceman performs, in step ST101, a field service such as maintenance and repair of products. In step ST102, if a work report from the field serviceman is filed after the field service, the work report is analyzed in step ST103. If an emergency situation where a number of identical claims exist is detected, a claim report is issued in step ST104 to the major subsidiary, which is an upper-level service layer.

In major subsidiaries, an employee confirms, in step ST105, the content of the claim report along with the independently collected various report information such as warrantee report data, call center data, set-up report data, service parts use data and claim report data. Then, the computer operator registers the confirmed information in the database. In step ST106, the operator checks the database for an existing solution to the claim of the claim report. If it is determined in step ST107 that the solution is present in the database, an answer document based on the solution is sent to the dealer in step ST108. On the other hand, if there is no existing solution, the operator accesses, in step ST109, the technical support system 1 in Tokyo over the Internet 26, which is an upper-level service layer. The claim is reported to the engineering and service department through the client web page, which is provided to the client terminal 24 of the major subsidiary by the technical support system 1.

In the engineering and service department, in step ST110, the technical support system 1 confirms and verifies the content of the claim report. In step ST111, it is checked whether there is a solution to the claim. If it has been determined in step ST112 that the solution is present in the database, an answer document based on this solution is sent to the major subsidiary in step ST113. On the other hand, if the solution is not present, the claim report is escalated to the product technology department at the upper service level in step ST114. In a case where the product technology department comprises, for example, a product planning section, a design and manufacturing section, and other sections, one of these sections is designated and a solution to the claim is requested therefrom. In FIG. 4, all the steps beginning with step ST110 are carried out within the technical support system 1.

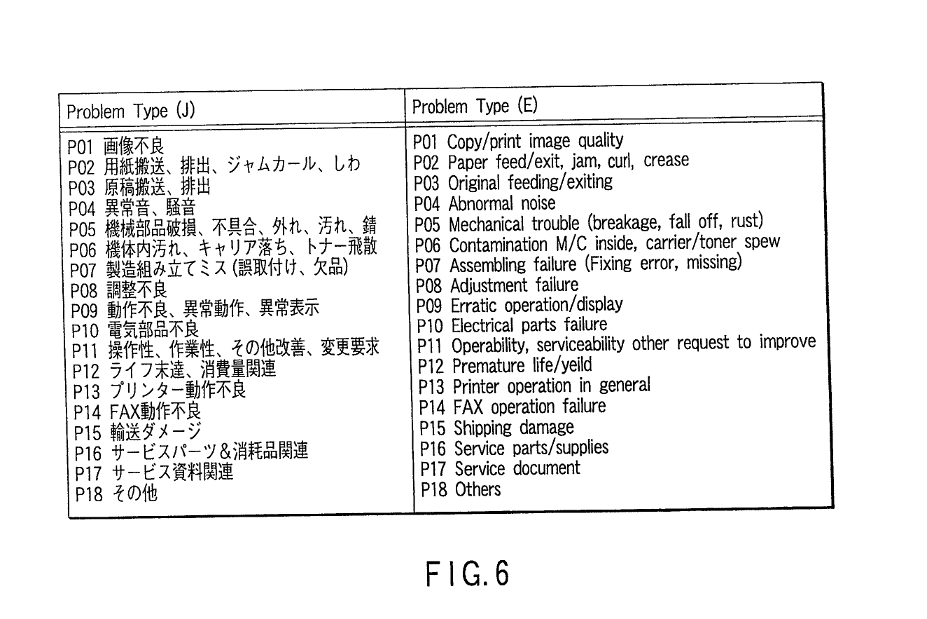

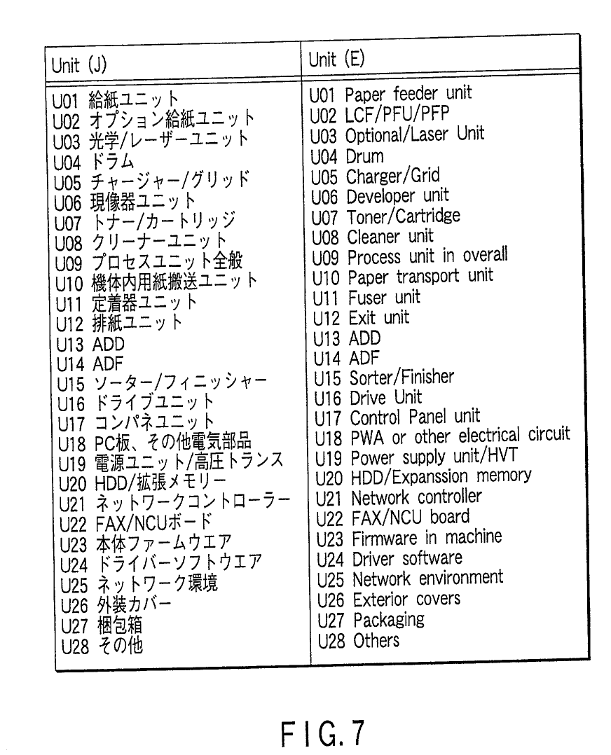

FIG. 5 illustrates a reporting process for an unformatted claim such as a claim report issued in the dealer. This reporting process is a process to be performed within the technical support system 1. If the reporting process is selected on the client web page, the CH section 14 performs, in step ST201, a knowledge base search for confirming the presence of similar claims specified by information available from the claim content input to the client web page in a format close to a natural language, for example, information on product units or problems. In the knowledge base search, product units and problems expressed in various local languages are converted to unit codes and problem codes, using synonym tables shown in FIGS. 6 and 7. The KB section 16 is searched on the basis of these codes. If it is determined in step ST202 that a solution to the similar claims is present in the KB section 16, an answer document based on this solution is automatically produced in step ST203 using a response assistance module 14A. In step ST204, the answer document is issued to the major subsidiary. In this case, the response assistance module 14A produces the answer document so as to meet the technical support policy which differs from market to market. Aside from the above-mentioned synonym tables, it is possible to use tables applicable to cases where different model numbers are assigned to the same models in accordance with different countries. In the synonym tables shown in FIGS. 6 and 7, English and Japanese synonyms are associated. However, these tables may be provided as conversion tables for unifying languages within the system by converting languages such as Japanese or German to English, or a standard language. Thereby, it becomes possible to find a solution to similar claims from major subsidiaries managing other market regions.

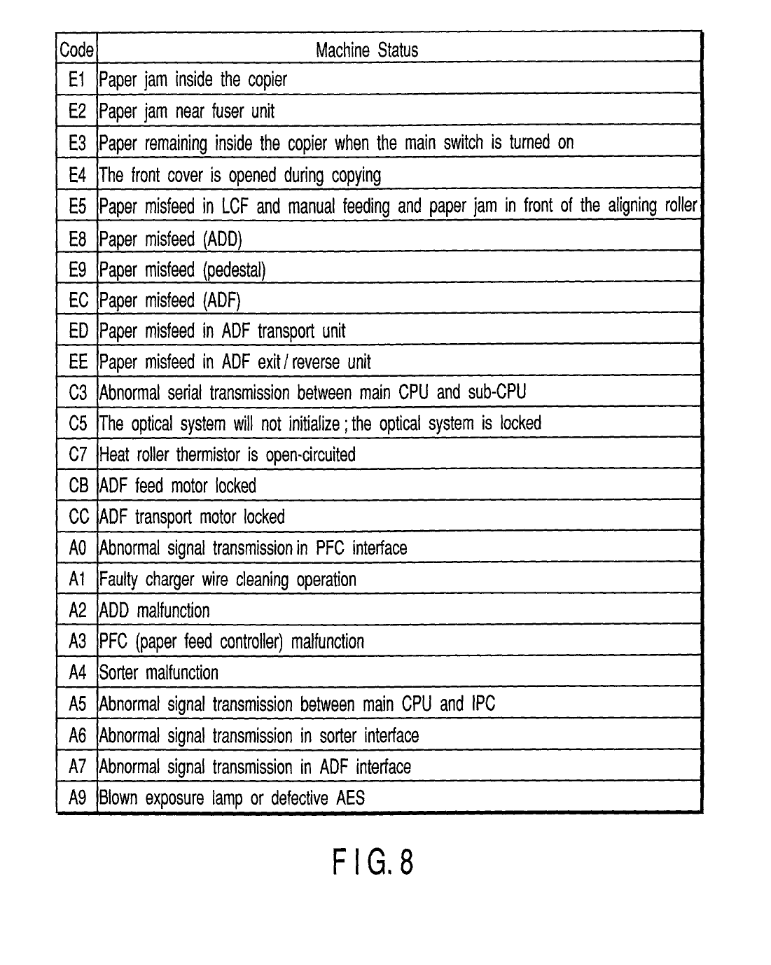

On the other hand, if a solution to the similar claims is not present in the KB section 16, a claim report is newly produced in step ST205 using a report assisting module 14B. The claim report is issued in step ST206. The report assisting module 14B automatically incorporates into the claim report the information available from the content of the claim input to the client web page, and requests input of information which is necessary for a study of a solution by the engineer but is lacking. Based on the information input in response to this request, the claim report is formatted. Specifically, as shown in FIG. 8, the production of the claim report requires information such as a) report source, b) rank of importance, c) claim category, d) claim title, e) claim details, and f) situation.

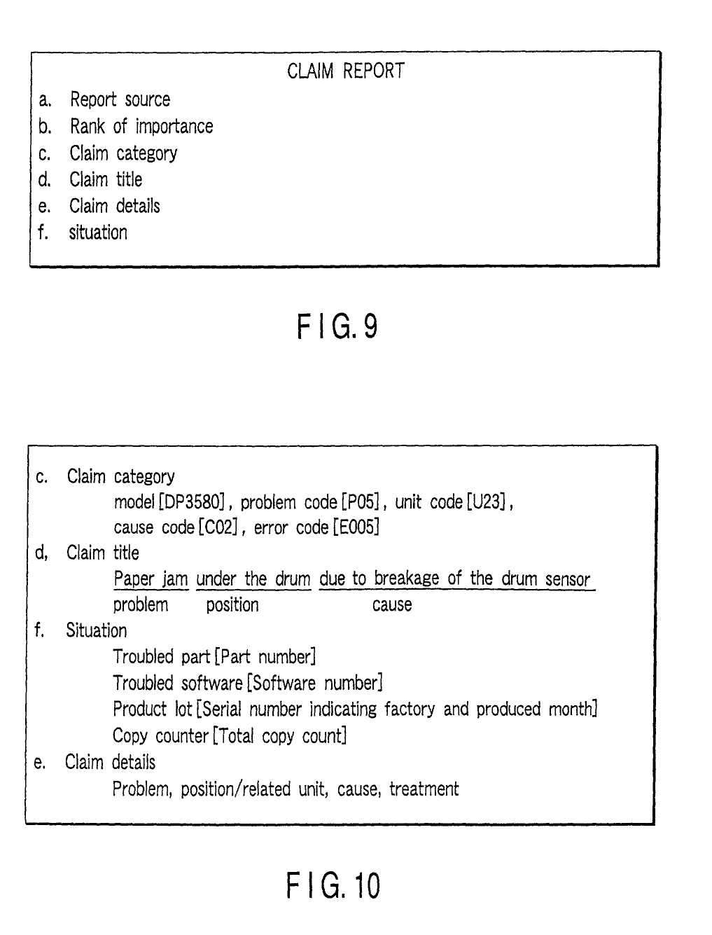

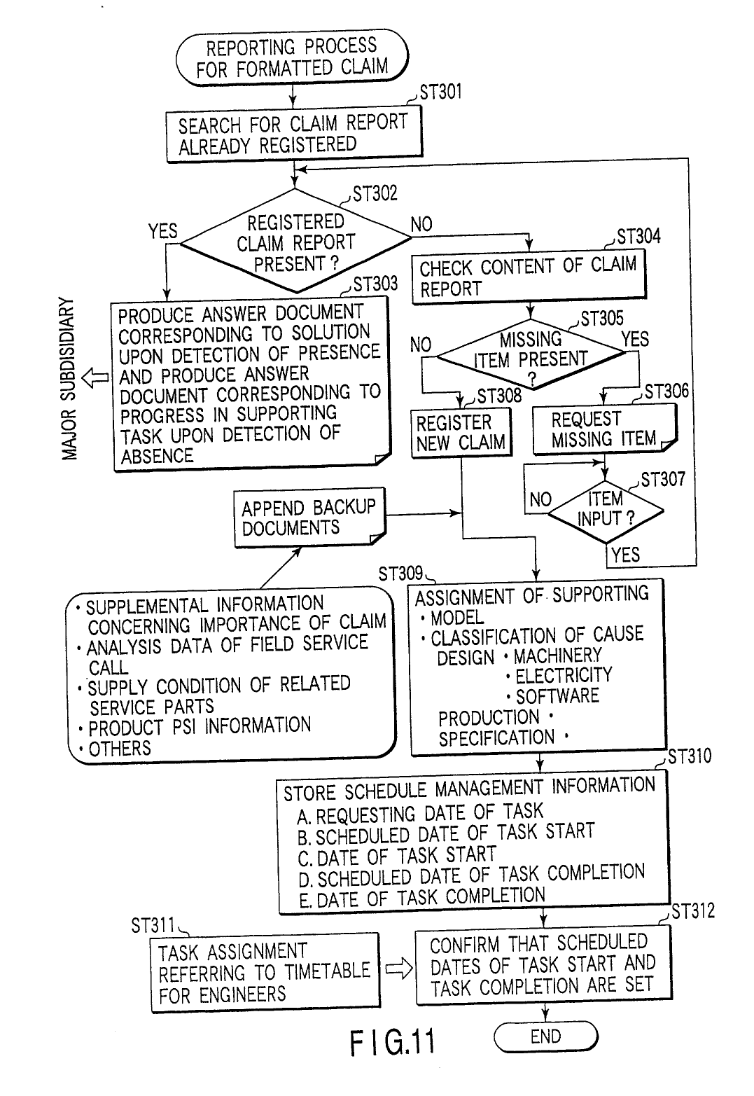

FIG. 9 shows details of items c, d, e and f incorporated in the claim report. Item c is prepared for searching for similar claims from a claim category on the basis of simple coincidence of keywords and codes, and item c includes a product model, a problem code, a unit code, a cause code and an error code. Item d is prepared for searching for similar claims on the basis of the claim title, and item d is produced as a phrase constructed by combining words indicative of definition information items such as a problem, a position and a cause. Examples of the claim title other than that shown in FIG. 9 are “Dark copy image due to poor adjustment in optical unit”, “Abnormal noise from drive gear in fuser unit”, and “Breakage of front cover due to poor package material.” Item e is prepared for searching for similar claims based on claim details and is produced as a free description including items such as a problem, position/related unit, cause and treatment. Item f is prepared for searching for similar claims based on situations, and it is produced to include a part number, software version number, part number indicative of a problem part, and total copy counter value.

FIG. 10 illustrates a reporting process for a formatted claim such as the claim report shown in FIG. 8. This reporting process is a process to be performed within the technical support system 1. This process is performed when the claim report has been issued in the reporting process illustrated in FIG. 5 and when a formatted claim report has been input by choosing on the client web page. In this reporting process, the CH section 14 performs in step ST301 a search for the claim report on the basis of the claim category, claim title, claim details and situation. If it is determined in step ST302 that the claim report has already been registered in the KB section 16, an answering document is automatically produced in step ST303 using the answer assisting module 14A and it is issued to the major subsidiary. In this case, where there is a solution to the claim report, the answer assisting module 14A produces an answering document based the solution. Where there is no solution, the answer assisting module 14A produces an answering document based on the state of progress in the supporting task.

On the other hand, if the claim report is not registered in the KB section 16, the content of the claim report is checked in step ST304 as to whether there is an item missing. If there is a missing item in step ST305, the input of this item is requested on the client web page in step ST306. After the input of information of this item is detected in step ST307, the KB section 16 is searched once again. If it is determined that the claim report is not registered in this case, too, it is confirmed in step ST304 that there is no missing item. Then, in step ST308, the claim report is newly registered in the KB section 16.

Subsequently, in step ST309, the CH section 14 performs a division designation process for assigning a supporting task to a division-in-charge in the product technology department, which is responsible for the registered claim report. Specifically, the product technology department is divided in advance into divisions for design relating to machinery, electricity and software, production, and specification. Thus, it is found from the content of the claim report which division is associated with the product model and the cause.

Then, in step ST310, the CH section 14 adds schedule management information to the claim report registered in the KB section 16, and appends thereto support backup documents obtained from the MIS section 12, and requests a support task for the claim report to the division-in-charge. This request is effected on an engineer web page provided by the SIP section 10 on the Internet 26 or intra-company LAN. The support backup documents comprise, for example, supplemental information concerning the importance or seriousness of the claim, the analysis data of a field service call, the supply condition of related service parts, the product PSI information, and others. The schedule management information includes data representative of a requesting date of a supporting task, a scheduled date of supporting task start, a date of supporting task start, a scheduled date of supporting task completion, a date of supporting task completion, and a supervisory engineer and a staff engineer in the division-in-charge. The data on the requesting date of the supporting task and the division-in-charge is automatically recorded by the CH section 14. The data on the scheduled date of supporting task start, the date of supporting task start, the scheduled date of supporting task completion, the date of supporting task completion, the supervisory engineer and the staff engineer are input and recorded on the engineer web page. On the engineer web page, the work schedule table stored in the MDB section 18 can be referred to so that the schedule of each engineer in the division-in-charge may be checked. Furthermore, in step ST311, the most suitable engineer for solving the claim is decided in consideration of the field-in-charge, experience and technical level. Besides, a message to the effect that a solution to the claim report is now being studied and a supporting task schedule are sent to the subsidiary.

The above-described claim reporting process is finished in step ST312 in which the data on the scheduled date of supporting task start, the scheduled date of supporting task completion, the supervisory engineer and the staff engineer is input and recorded on the engineer web page.

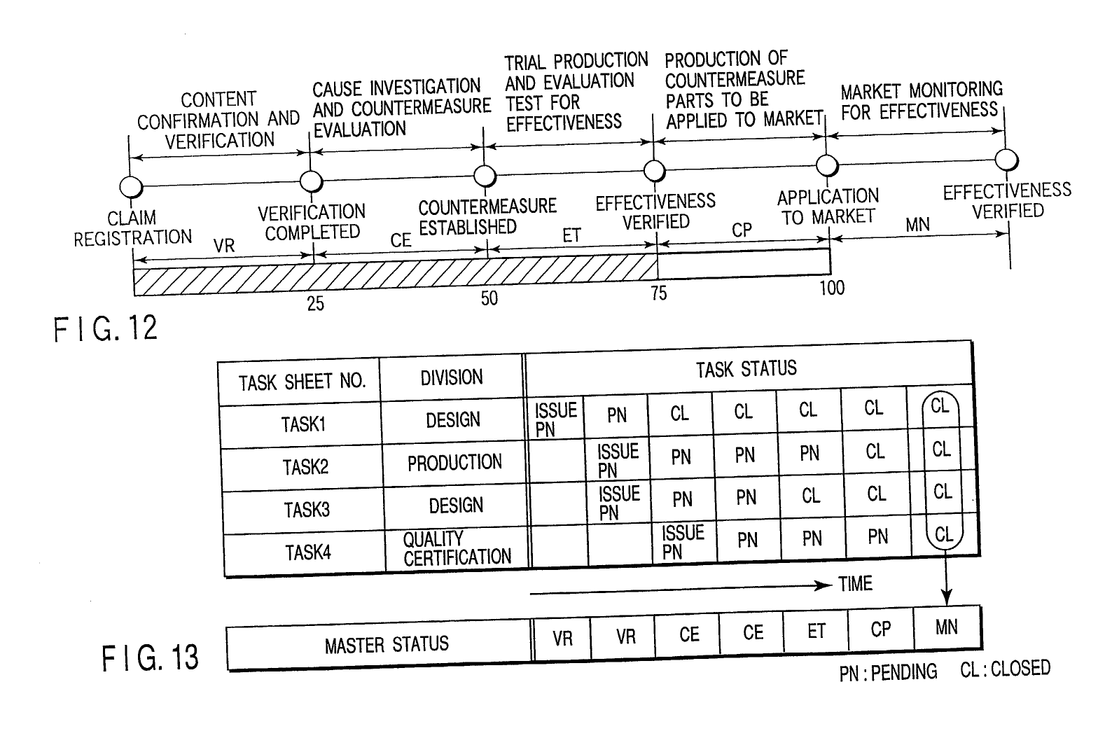

FIG. 12 shows a stepwise transition of a market countermeasure task carried out for the claim report carried by the whole product technology department. If the claim report is accepted in the product technology department, the content of the claim report is confirmed and verified in a first step VR. The cause is investigated and its solution is estimated in a second step CE. Trial production and effectiveness test of a countermeasure part is carried out in a third step. If the content of the claim requires part alternation in the future, parts of the countermeasure are prepared for market application in a fourth step, and effectiveness of the countermeasure parts in the market is monitored in a fifth step.

The CH section 14 has a function of presenting the state of progress in the market countermeasure task in a visible format as shown in FIG. 12. The results of the verification step VR, investigation and estimation step CE, trial production and effectiveness test step ET, and market application part preparation step CP, and countermeasure effectiveness monitor step MN are delivered as task reports to the technical support system 1. In the technical support system 1, the state of progress in the market countermeasure task is indicated by a status or percentage, and is sequentially changed based on task reports, like VR, CE, ET, CP and MN. In addition, the state of progress in the market countermeasure task may be managed with task sheets, by which the master status shown in FIG. 13, for example, is automatically changed within the technical support system 1. The CH section 14 issues the task sheets for the market countermeasure task which is shared among technical divisions according to the new claim report, and updates the state of progress in the market countermeasure task upon receipt of the task sheet returned from each of the technical divisions as the task report.

As shown in FIG. 13, a task sheet TASK1 is issued to a design division. At this time, the master status is changed to the step VR of confirming and verifying the content of the claim report. Thereafter, task sheets TASK2 and TASK3 are simultaneously issued to a production division and design division. At this time, the task of the task sheet TASK1 is uncompleted, and thus the master status is maintained in the step VR. Thereafter, when the task of the task sheet TASK1 is completed at the design division, and the task sheet TASK1 is returned to the CH section 14, the master status is changed to the step CE of performing the cause investigation and solution estimation. Moreover, with the returning of the task sheet TASK1, a task sheet TASK4 is issued to a quality certification division. Thereafter, while any of the task sheets TASK1 to TASK3 are not returned, the master status is maintained in the step CE. When the task of the task sheet TASK3 is completed in the design division, and the task sheet TASK3 is returned to the CH section 14, the master status is changed to the step ET of performing the trial production and effectiveness test of the countermeasure part. Furthermore, when the task of the task sheet TASK2 is completed in the production division, and the task sheet TASK2 is returned to the CH section 14, the master status is changed to the step CP of performing preparation of the countermeasure parts for market application. When the task of the task sheet TASK4 is completed in the quality certification division, and the task sheet TASK4 is returned to the CH section 14, the master status is changed to the step MN indicating completion of the countermeasure task. Additionally, in the step MN, details of the countermeasure are further delivered as a report of invention to a patent division via the interface 22. This step MN is set in a condition where all the task sheets are returned to close the task statuses, and then the master status is closed.

In the technical support system, the CH section 14 issues task sheets for a market countermeasure task which is shared among technical divisions according to the new claim report, and updates the state of progress in the market countermeasure task upon receipt of the task sheet returned from each of the technical divisions. Therefore, the technical divisions can simultaneously carry out subtasks of the market countermeasure task. Additionally, even when it is necessary to await a task result from another technical division, the next subtask can be started without delay, immediately after acquisition of the task result. Therefore, the claim concerning the product can speedily be solved as a whole.

Moreover, the new claim report in which at least a claim title is structured as a combination of predetermined items of definition information on the basis of the claim content input to the client web page is registered in the knowledge base section, and is managed as an unsolved claim requiring an answer from the engineer. Therefore, it can be checked with a high precision whether or not a solution is already available with respect to the claim report. If the solution is found by a search, the claim can quickly be solved based on the solution. Accordingly, labor of the engineer required for verifying a necessity of the market countermeasures can be saved.

The state of progress in the market countermeasure task is visualized by status or percentage, and is updated upon receipt of each task report, in a sequence of VR, CE, ET, CP, MN shown in FIG. 12. Therefore, it is easy to grasp the progress state.

As for the claim report that exists in the KB section 16 but has no available solution, the progress state of the supporting task is included in the answer document. Thus, clients such as the subsidiary can easily know the time needed to obtain a solution.

In the aforementioned embodiment, the technical support system 1 which handles claims concerning the products such as copiers and facsimiles has been described, but the present invention is not limited to this. Moreover, the present invention can be applied not only to a worldwide technical service network but also to a case in which a plurality of market areas exist in a single country. Furthermore, at least one of the SIP section 10, MIS section 12, CH section 14, KB section 16, MDB section 18, and DWH section 20 of the technical support system 1 may be composed of a server computer in which the application software with the functions described in the aforementioned embodiment is installed from a recording medium or downloaded via the interface 22.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A technical support system comprising:
a service information portal section which provides web pages as an information input and output interface;
a knowledge base section which stores various claim reports and solutions related to the claim reports; and
a claim handling section which registers in said knowledge base section a new claim report in which at least a claim title is structured as a combination of predetermined items of definition information on the basis of a claim content input to a client web page, and manages the registered new claim report as an unsolved claim requiring an answer from an engineer;
wherein said claim handling section is configured to issue task sheets for a market countermeasure task which is shared among technical divisions according to the new claim report and to update the state of progress in the market countermeasure task upon receipt of the task sheet returned from each of the technical divisions.

2. The technical support system according to claim 1, wherein said claim handling section is configured to visualize the state of progress in the market countermeasure task.

3. A technical support method using a knowledge base section which stores various claim reports and solutions related to the reports, said method comprising:
a step of providing web pages as an information input and output interface;
a step of registering in said knowledge base section a new claim report in which at least a claim title is structured as a combination of predetermined items of definition information on the basis of a claim content input to a client web page, and managing the registered new claim report as an unsolved claim requiring an answer from an engineer; and
a step of issuing task sheets for a market countermeasure task which is shared among technical divisions according to the new claim report, and updating the state of progress in the market countermeasure task upon receipt of the task sheet returned from each of the technical divisions.

4. The technical support method according to claim 3, wherein said progress state updating step is configured to visualize the state of progress in the market countermeasure task.

5. A recording medium having a program recorded for a technical support system server including a claim handling section which registers in a knowledge base section a new claim report in which at least a claim title is structured as a combination of predetermined items of definition information on the basis of a claim content input to a client web page, and manages the registered new claim report as an unsolved claim requiring an answer from the engineer, said program being executable for causing said claim handling section to perform a process of issuing task sheets for a market countermeasure task which is shared among technical divisions according to the new claim report, and updating the state of progress in the market countermeasure task upon receipt of the task sheet returned from each of the technical divisions.

6. The recording medium according to claim 5, wherein the program is configured such that said claim handling section performs a process of visualizing the state of progress in the market countermeasure task.
